(19) United States
(12) Patent Application Publication
(10) Pub. No.: US 2015/0099489 A1
(43) Pub. Date: Apr. 9, 2015

(54) SENDING AN ONLINE SOCIAL NETWORK MESSAGE USING A TEXTSITE APPLICATION VIA A TEXT MESSAGE

(71) Applicant: Giridhar Mohan Bhageshpur, Bangalore (IN)

(72) Inventor: Giridhar Mohan Bhageshpur, Bangalore (IN)

(73) Assignee: INTUIT INC., Mountain View, CA (US)

(21) Appl. No.: 14/070,396

(22) Filed: Nov. 1, 2013

(30) Foreign Application Priority Data
Oct. 4, 2013 (IN) 1146/KOL/2013

(51) Int. Cl. H04W 4/12

(52) U.S. Cl. CPC H04W 4/12
USPC 455/412.1; 455/466

(57) ABSTRACT

A method for delivering an online social network (OSN) message. The method includes obtaining delivery status and content of the OSN message, wherein the OSN message is sent by a first user using an OSN application to a second user, generating, by a computer processor, a text message comprising the content of the OSN message, and sending, by the computer processor and in response to the delivery status meeting a pre-determined criteria, the text message using a text messaging service (TMS) to the second user, wherein the OSN application is used by the first user to exchange social interaction messages with OSN friends of the first user, and wherein the second user is not able to view the OSN message using the OSN application.

### CROSS-REFERENCE TO RELATED APPLICATIONS

This application claims priority, under 35 U.S.C. §119(a), to Indian Patent Application No. 1146/KOL/2013, filed on Oct. 4, 2013, and entitled: “SENDING AN ONLINE SOCIAL NETWORK MESSAGE USING A TEXTSITE APPLICATION VIA A TEXT MESSAGE”.

### BACKGROUND

Generally, a social network is a social structure (e.g., community) made of members (e.g., a person or a user) connected by social relationships such as friendship, kinship, relationships of beliefs, knowledge, prestige, culture, etc. Online social network (OSN) is a social network that is formed based on computer mediated social interaction/networking that allows the users to establish “friend” relationships and exchange information (e.g., sending messages, posting comments, etc.) via a computer network, such as the Internet. Throughout this disclosure, the terms “social network,” “online social network,” and “OSN” may be used interchangeably and refer to a computer mediated social network having computer servers to facilitate social interaction among members of the social network. Examples of computer mediated social network application include those provided by Facebook® (a registered trademark of Facebook, Inc., Palo Alto, Calif.), Myspace® (a registered trademark of Myspace, Inc., Beverly Hills, Calif.), Twitter® (a registered trademark of Twitter, Inc., San Francisco, Calif.), LinkedIn® (a registered trademark of LinkedIn, Ltd., Mountain View, Calif.), etc.

Today's cellular phone services allow users using mobile devices, such as cellular phones, to send and receive messages using a text messaging service, such as SMS (i.e., Simple Messaging Service), MMS (i.e., multimedia messaging service), etc. Certain cellular phones (referred to as smartphones) are equipped with Internet browsing capability in addition to the text messaging capability. The Internet browsing is typically offered by Internet service providers as a subscribed service, referred to as a data plan or Internet data plan. For example, the cellular phone service providers may provide wireless data plans using wireless Internet connections. Other service providers may provide wired data plans using wired Internet connections. Having an Internet data plan subscription and in an area with proper wired or wireless Internet coverage, an OSN user is provided with web browsing capability to access the OSN, in addition to obtaining other information such as phone numbers for services, particular destination locations, etc.

### SUMMARY

In general, in one aspect, the invention relates to a method for delivering an online social network (OSN) message. The method includes obtaining delivery status and content of the OSN message, wherein the OSN message is sent by a first user using an OSN application to a second user, generating, by a computer processor, a text message comprising the content of the OSN message, and sending, by the computer processor and in response to the delivery status meeting a pre-determined criteria, the text message using a text messaging service (TMS) to the second user, wherein the OSN application is used by the first user to exchange social interaction messages with OSN friends of the first user, and wherein the second user is not able to view the OSN message using the OSN application.

In general, in one aspect, the invention relates to a system for delivering an online social network (OSN) message. The system includes (i) a computer processor, (ii) memory storing instructions executable by the computer processor, wherein the instructions comprise (1) an OSN application configured to obtain delivery status and content of the OSN message, wherein the OSN message is sent by a first user to a second user, and exchange, by the first user, social interaction messages with OSN friends of the first user, wherein the second user is not able to view the OSN message using the OSN application, (2) a message manager configured to determine the delivery status as meeting a pre-determined criteria, and generate a text message comprising the content of the OSN message, and (3) a text messaging service (TMS) module configured to send, in response to determining the delivery status as meeting the pre-determined criteria, the text message using a text messaging service (TMS) to the second user of the OSN application, and (iii) a repository for storing the OSN message.

In general, in one aspect, the invention relates to a non-transitory computer readable storage medium comprising software instructions for delivering an online social network (OSN) message, that when executed, comprise functionality for obtaining delivery status and content of the OSN message, wherein the OSN message is sent by a first user using an OSN application to a second user, generating a text message comprising the content of the OSN message, and sending, in response to the delivery status meeting a pre-determined criteria, the text message using a text messaging service (TMS) to the second user, wherein the OSN application is used by the first user to exchange social interaction messages with OSN friends of the first user, and wherein the second user is not able to view the OSN message using the OSN application.

Other aspects of the invention will be apparent from the following description and the appended claims.

### BRIEF DESCRIPTION OF DRAWINGS

FIGS. 1A and 1B show block diagrams of a system in accordance with one or more embodiments of the invention.

FIGS. 2A and 2B show flow charts of methods in accordance with one or more embodiments of the invention.

FIGS. 3A, 3B, 3C, 3D, 3E, 3F, 3G, 3H, 3I, and 3J show screenshots of an example in accordance with one or more embodiments of the invention.

FIGS. 4A, 4B, 4C, 4D, and 4E show an example in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for an offline user to send and receive social network (OSN) messages via a text messaging service (TMS) based content platform. In one or more embodiments of the invention, an OSN user who is away from any wired Internet connection (e.g., a desktop computing device) but (i) does not have Internet browsing capability on his/her mobile device, (ii) does not subscribe to any wireless data plan for browsing the Internet, and/or (iii) is in an area without proper wireless Internet coverage, is referred to as an offline OSN user or simply offline user. Due to the Internet access limitation of the offline user, viewing the OSN messages directly using the OSN application is not possible. In one or more embodiments, an OSN message is converted into a TMS message when it is determined that an OSN message recipient has not viewed the OSN message within a pre-determined time period or if the OSN message recipient is offline and cannot view the OSN message. Accordingly, this TMS message is sent from the TMS based content platform on behalf of the OSN message sender to the intended OSN message recipient. In response to receiving this TMS message, the intended OSN message recipient may reply to the OSN message via the TMS based content platform.

In one or more embodiments, the TMS based content platform is a global textsite platform (GTP) providing published information as one or more textsites. Each textsite (also referred to as an application of the GTP) is accessible by the user sending a publisher registered keyword via a text message (referred to as a GTP message) to the GTP. Each publisher registered keyword uniquely identifies one textsite (i.e., application) within the GTP and is also referred to as the application name of the application. The GTP and accessing the textsites using corresponding publisher registered keywords are described in detail throughout this disclosure. Throughout this disclosure, the terms “textsite,” “application,” and “textsite application” may be used interchangeably depending on the context. Further, the terms “publisher registered keyword,” “registered keyword,” “registered unique keyword,” and “application name” may also be used interchangeably depending on the context. Accordingly, accessing the textsites using corresponding registered unique keywords is also referred to as accessing the applications using corresponding application names.

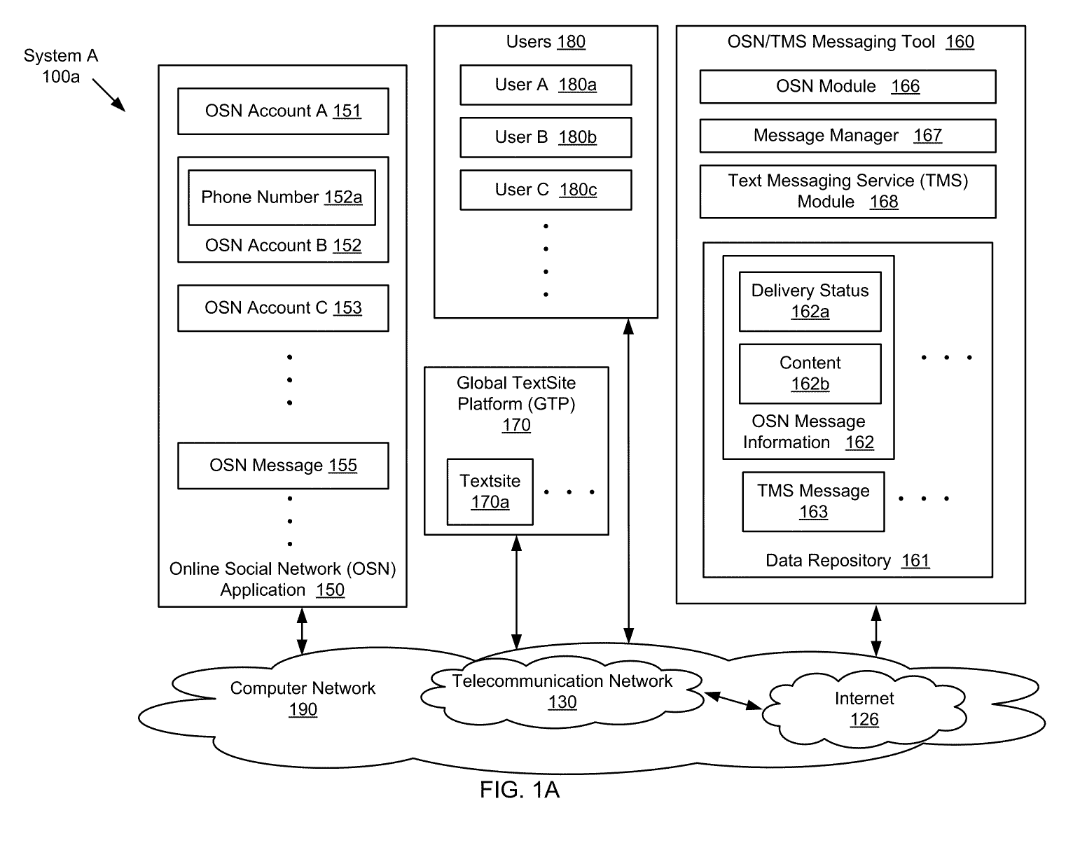

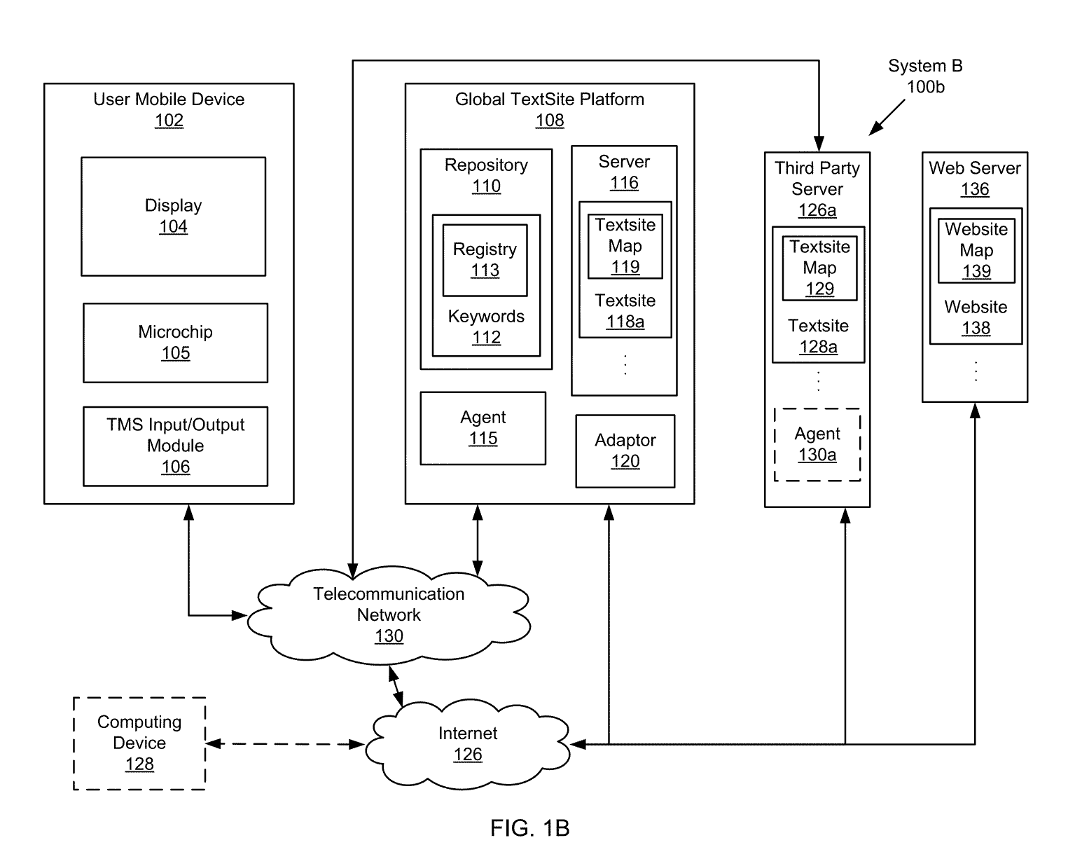

FIG. 1A shows a block diagram of a system A (100a) for sending an online social network (OSN) message using a textsite application via a text message in accordance with one or more embodiments of the invention. Specifically, the system A (100a) includes an OSN application (150), a global textsite platform (GTP) (170) (i.e., the TMS based content platform), and an OSN/TMS messaging tool (160) coupled via a computer network (190). In one or more embodiments of the invention, one or more of the modules and elements shown in FIG. 1A may be omitted, repeated, and/or substituted. Accordingly, embodiments of the invention should not be considered limited to the specific arrangements of modules shown in FIG. 1A.

In one or more embodiments of the invention, the computer network (190) may include a telecommunication network (130) (e.g., a cellular phone network, a public switched telephone network (PSTN), etc.), a wide area network, a local area network, or any other suitable network that facilitates the exchange of messages from one part of the network to another. In one or more embodiments, the computer network (190) is coupled to or overlap with the Internet (126). In one or more embodiments, each user of the users (180), the OSN application (150), the GTP (170), and the OSN/TMS messaging tool (160) may include any computing device configured with computing, data storage, and network communication functionalities. Generally, the GTP (170) is configured with high performance computing capability and large amount of data storage capacity to support multiple users (i.e., users (180)) in a client server application environment. In one or more embodiments, the computing device used by each user of the users (180) may be a mobile device, such as a cellular phone or a smartphone.

In one or more embodiments, the users (180) are members of an OSN. In one or more embodiments, the aforementioned computer mediated social interaction and networking of the OSN are based on the OSN application (150). In particular, each member of the OSN has an OSN account within the OSN application (150). For example, the OSN account A (151), OSN account B (152), OSN account C (153), etc. belong to the user A (180a), user B (180b), user C (180c), etc. In one or more embodiments, the OSN application (150) is message based and provides a variety of ways (e.g., e-mail, instant messaging service, etc.) for the users (180) to interact socially via social network messages, referred to as OSN messages. In one or more embodiments, the OSN messages (e.g., OSN message (155)) are messages exchanged via the Internet (126) by OSN users using the OSN application (150) to interact socially. In contrast, the TMS messages are exchanged via the telecommunication network (130). For example, the TMS messages may be based on SMS, MMS, other text messaging service known to those skilled in the art, or any text messaging service that may be developed in the future.

As noted above, each user (e.g., an individual, a person) of the users (180), such as user A (180a), user B (180b), user C (180c), etc., is a user of the OSN application (150). In one or more embodiments, some of the users (180) (e.g., user B (180b)) are also users of the GTP (170) and the OSN/TMS messaging tool (160). In one or more embodiments of the invention, content provided by the GTP (170) may be organized/published as the aforementioned textsites, such as the textsite (170a). In one or more embodiments of the invention, the OSN/TMS messaging tool (160), or a portion thereof, may be integrated with the GTP (170). For example, the OSN/TMS messaging tool (160), or a portion thereof, may be integrated with the textsite (170a). In particular, one or more functionality of the OSN/TMS messaging tool (160) may be activated by sending a registered keyword of the textsite (170a) in a GTP message to the GTP (170). Detailed examples of the GTP (170) and various GTP messages are described in reference to FIGS. 1B, 2B, and FIGS. 3A, 3B, 3C, 3D, 3E, 3F, 3G, 3H, 3I, and 3J below.

As shown in FIG. 1, the OSN/TMS messaging tool (160) includes an OSN module (166), a message manager (167), a TMS module (168), and a data repository (161) storing information used and/or generated by these elements of the OSN/TMS messaging tool (160). For example, information regarding an OSN message (155) exchanged using the OSN application (150) among users (180) may be obtained and stored in the data repository (161) as the OSN message information (162). Each of these elements of the OSN/TMS messaging tool (160) is described in detail below.

In one or more embodiments of the invention, the OSN/TMS messaging tool (160) includes the OSN module (166) that is configured to obtain information regarding the OSN message (162), which is sent by the user A (180a) to the user B (180b) using the OSN application (150). In particular, the OSN application (150) is accessed by the user A (180a) and the user B (180b) under the OSN account A (151) and the OSN account B (152), respectively, based on respective network data services (i.e., data plans) subscribed by the user A (180a) and the user B (180b). In one or more embodiments, the information regarding the OSN message (162) includes delivery status (162a) and content (162b) that are obtained by the OSN module (166) and stored in the data repository (161) as the OSN message information (162). In one or more embodiments, the delivery status (162a) and content (162b) are obtained by the OSN module (166) via an application programming interface of the OSN application (150). In one or more embodiments, the delivery status (162a) includes an indication whether the OSN message (155) has been delivered, whether the recipient (i.e., user B (180)) has viewed the OSN message (155), and/or whether the recipient (i.e., user B (180)) is offline from his/her subscribed network data service and not able to view the OSN message (155) using the OSN application (150).

In one or more embodiments of the invention, the OSN/TMS messaging tool (160) includes the message manager (167) that is configured to generate a TMS message (163) that is semantically equivalent to the OSN message (155), when the user B (180b) (i.e., the recipient of the OSN message (155)) has not or cannot view the OSN message (155) directly using the OSN application (150). Specifically, the message manager (167) first determines that the delivery status (162a) meets a pre-determined criteria. In one or more embodiments, the pre-determined criteria includes the indication that the user B (180) has not viewed the OSN message (155) within a pre-determined time period since the OSN message (155) was sent by the user A (180a) using the OSN application (150). In one or more embodiments, the pre-determined criteria includes the indication that the user B (180) has not viewed the OSN message (155) within a pre-determined time period since the OSN message (155) was delivered to the OSN account B (152) within the OSN application (150). In one or more embodiments, the pre-determined criteria includes an indication that the user B (180b) is offline from his/her subscribed network data service and is not able to view the OSN message (155) using the OSN application (150).

In response to determining that the delivery status (162a) meets the pre-determined criteria, the message manager (167) generates the TMS message (163) based on the content (162b). As noted above, the TMS message (163) is semantically equivalent to the OSN message (155).

In one or more embodiments, the OSN/TMS messaging tool (160) includes the TMS module (168) that is configured to send the TMS message (163) using a text messaging service (TMS) to the intended recipient (i.e., user B (180b)). For example, the TMS message (163) is sent to the user B (180b) based on the phone number (152a) of the user B (180b) that is stored in the OSN account B (152). In one or more embodiments, the TMS module (168) provides the TMS message (163) and the phone number (152a) to the GTP (170) for sending to the user B (180b) as a GTP message. Accordingly, the user B (180b) receives and views this GTP message as a semantically equivalent version of the OSN message (155) without using any Internet data plan. Detailed examples of sending and receiving GTP messages without using Internet data plan are described in reference to FIGS. 1B, 2B, and FIGS. 3A, 3B, 3C, 3D, 3E, 3F, 3G, 3H, 3I, and 3J below.

In one or more embodiments, the TMS module (168) is further configured to receive, in response to sending the TMS message (163) and using the TMS, a reply text message (not shown) from the user B (180b) to reply to the OSN message (155) from the user A (180a). For example, the reply text message may be received via the GTP as a reply GTP message from the user B (180b). In such embodiments, the message manager (167) is further configured to generate an OSN reply message (not shown) semantically equivalent to (or containing content of) the reply text message. This OSN reply message is then provided by the OSN module (166) to the OSN application (150) for sending to the user A (180a). Although the user B (180b) is offline and cannot access the OSN application (150) directly, the OSN reply message is sent to the user A (180a) from the OSN account B (152) as initiated by the OSN module (166) on behalf of the user B (180b).

In one or more embodiments, the OSN message (155) is a group chat message and has multiple recipients, including the user C (180c) in addition to the user B (180b). In such embodiments, the OSN reply message is a group reply message and is also sent to the user C (180c) from the OSN account B (152) as initiated by the OSN module (166) on behalf of the user B (180b).

FIG. 1B shows a block diagram of a system (100b) for accessing content from a textsite in accordance with one or more embodiments of the invention. Specifically, FIG. 1B shows the global textsite platform (GTP) (108), a user mobile device (102), and a computing device (128) coupled via the telecommunication network (130) and/or the Internet (126). In one or more embodiments of the invention, the system (100b) is an example of the system (100a) depicted in FIG. 1A above. In one or more embodiments, the GTP (108) with the textsite (118a) is an example of the GTP (170) with the textsite (170a) depicted in FIG. 1A above. In one or more embodiments of the invention, one or more of the modules and elements shown in FIG. 1B may be omitted, repeated, and/or substituted. Accordingly, embodiments of the invention should not be considered limited to the specific arrangements of modules shown in FIG. 1B.

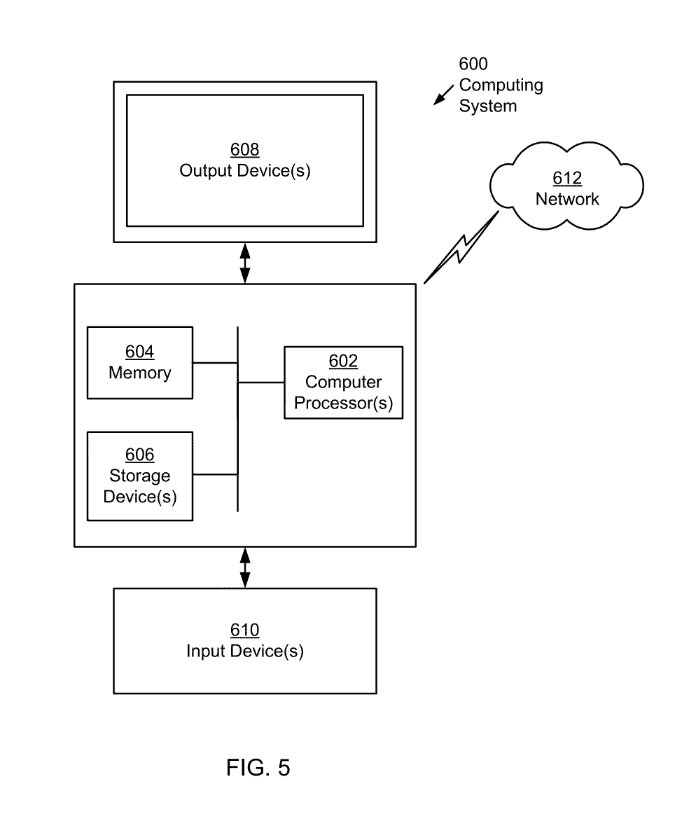

In one or more embodiments of the invention, the global textsite platform (108) executes on one or more computing device(s) (e.g., a server, a computer system as shown in FIG. 5 and described below, etc.) and may be hosted by an entity, such as a corporation. In one or more embodiments of the invention, the global textsite platform (108) is associated with a platform syntax that is specific to the global textsite platform (108) and facilitates communication via a TMS. In one or more embodiments of the invention, the global textsite platform (108) may be associated with different unique phone numbers or codes corresponding to each different geographic location. Alternatively, a single, unique global number/code may be associated with the global textsite platform (108). In one or more embodiments of the invention, the global textsite platform (108) includes a repository (110) for storing keywords (112), a server (116) configured to host a plurality of textsites (e.g., textsite (118a)), an agent (115), and an adaptor (120). Those skilled in the art will appreciate that the server (116) may be any computing device with a large storage capacity.

The repository (110) may be any datastore (flat file, hierarchical file, relational database, enterprise-wide database, etc.) capable of storing data, regardless where or in what form the data originates. Keywords (112) may be reserved or pre-designated keywords maintained by the platform as part of the platform syntax, and publisher keywords that are registered by publishers for each textsite authored by a publisher. In one or more embodiments of the invention, pre-designated keywords and publisher registered keywords are unique. That is, no two keywords from the group of keywords that are pre-designated as platform syntax or the group of keywords provided by a publisher are allowed to be identical. In fact, in one or more embodiments of the invention, the keywords (112) are closely controlled by the global textsite platform (108) in an effort to eliminate duplicates. Navigating keywords, which a publisher defines for a textsite that is associated with a unique registered keyword, are also used. Navigating keywords are not required to be unique. For example, two distinct publishers with distinct registered keywords representing a first and a second textsite may use the same navigating keyword for different text pages associated with the first and second textsites.

In one or more embodiments, a portion of the keywords (112) is organized as a registry (113) storing a number of registered unique keywords each used as a site identifier and associated with metadata describing a mechanism for accessing corresponding site content, such as content stored in the textsite (118a), etc. In one or more embodiments, the registered unique keywords (i.e., used as site identifiers) are registered by textsite content publishers with relevant information processed into associated metadata. In one or more embodiments, the textsite (118a) may be hosted by the global textsite platform (108) on behalf of a first publisher or may be an in-house textsite maintained by the global textsite platform (108). In such embodiments, the metadata associated with the registered unique keyword (i.e., used as site identifiers) includes an internal link to the textsite (118a) within the global textsite platform (108).

In one or more embodiments, the textsite (128a) is published by a second publisher that has registered with the global textsite platform (108) but is hosted on a separate third party server (126a). In such embodiments, the metadata associated with the registered unique keyword (i.e., used as site identifier) includes an access path for the global textsite platform (108) to access the third party server (126a) via the telecommunication network (130) and/or the Internet (126). In one or more embodiments, the third party server (126a) may include agent (130a) configured with similar functionalities as those of the agent (115). For example, the agent (130a) may be provided to an operator of the third party server (126a) by an operator of the GTP (108) under a pre-determined business agreement (e.g., a licensing agreement).

In one or more embodiments, contents of the website (138) are converted by the global textsite platform (108) to be accessible to a user via TMS. In such embodiments, the metadata associated with the registered unique keyword includes an access path for the global textsite platform (108) to access the web server (136) via the Internet (126) and identifies whether the contents of the website (138), or a portion thereof, are converted dynamically (i.e., on demand) or statically (i.e., pre-converted and stored).

Generally, a publisher may be any person or entity that publishes information/content of a textsite (e.g., textsite (118a)) for users to access via a text messaging service or other network service. More specifically, a publisher may be any developer or service provider that provides a service or a product for users. For example, a publisher may be a restaurant owner that creates a textsite to provide information about his/her restaurant.

In one or more embodiments, a user is defined as a person or entity accessing content published by publishers and registered with the global textsite platform (108). As noted above, the published and registered content may be hosted by the global textsite platform (108). In one or more embodiments, a user is a person or entity with a mobile device that does not have a data plan subscription. Rather, the user is able to obtain data using the mobile device only via a TMS. That is, embodiments of the invention pertain specifically to users accessing content only via a TMS. Those skilled in the art will appreciate, however, that although embodiments of the invention target users that communicate via a TMS, the invention is not limited to such users. Specifically, while embodiments of the invention are directed to providing access to textsites to users using a mobile phone via a TMS, some users may be provided with the capability to access content on the global textsite platform (108) via a computing device (128), such as a desktop computer, a laptop computer, a thin computer, a combination thereof, or any other suitable electronic computing device that is capable of connecting to the global textsite platform (108) via the Internet (126). For example, in one or more embodiments, a user may use a text message emulator executing on the computing device (128) to connect to the global textsite platform (108) via the Internet (126). Alternatively, users with smart phones and/or mobile devices that support Internet browsing functionality could access content on the global textsite platform (108) using the Internet (126).

Further as shown in FIG. 1B, a user may possess the user mobile device (102) that is communicatively coupled to the global textsite platform (108) via the telecommunication network (130) and the Internet (126). The user mobile device (102) includes a display (104), a microchip (105), and a TMS input/output module (106). The user mobile device (102) may be any mobile device, such as a Code Division Multiple Access (CDMA) device, a global system mobile (GSM) device, a 3G device, a 4G device, a smart phone, a tablet, a pad device, a gaming device, a personal digital assistant, or any other suitable mobile device that includes text messaging functionality. In one or more embodiments of the invention, the user mobile device (102) is operatively connected to a global textsite platform (108) via a telecommunication network (130). The telecommunication network (130) may be any network that facilitates the exchange of messages from one part of the network to another. For example, the telecommunication network (130) may be a wide area network, a local area network, a public switched telephone network (PSTN), or any other suitable network for exchanging messages between the global textsite platform (108) and the user mobile device (102).

The display (104) of the user mobile device (102) may be a display screen using technology such as liquid crystal display (LCD), a light emitting diode (LED), organic light emitting diode (OLED), or any other suitable type of display screen capable of displaying the content of received text messages and the content of a text message that is being composed on the user mobile device (102). The microchip (105) may be any tangible hardware processor(s) or microprocessor(s) for executing the functionalities of the user mobile device (102). More specifically, the microchip (105) executes the software application(s) that provide functionalities such as browsing, text messaging, maintaining a contact list and making phone calls, etc. The TMS input/output module (106) may be a virtual keyboard, a physical keyboard, or any other input/output device(s) or button(s) that allows the publisher to compose text messages and receive and read text message responses.

In the user system (100b) of FIG. 1B, the global textsite platform (108) is configured to receive a text message from the user mobile device (102) that includes a request to access a textsite hosted by the global textsite platform (108). Further, the global textsite platform (108) is configured to process the request received from the user mobile device (102), and to provide the content from the desired textsite to the user's mobile device (102) via a TMS.

To facilitate this interaction with a user mobile device (102), the global textsite platform (108) includes an agent (115). In one or more embodiments of the invention, the agent (115) may be software that is the component of the global textsite platform (108), which communicates with a user mobile device (102). Specifically, the agent (115) is configured with functionality to receive a text message (i.e., a user message) from a user mobile device (102), parse the text message for the relevant keywords or platform-specific syntax, and respond to the user request by identifying and retrieving the content from the requested textsite/converted website for delivering back to the user mobile device (102) in accordance with one or more embodiments of the invention. In one or more embodiments, the content is delivered to the user mobile device (102) in a text message sent from the global textsite platform (i.e., a GTP message).

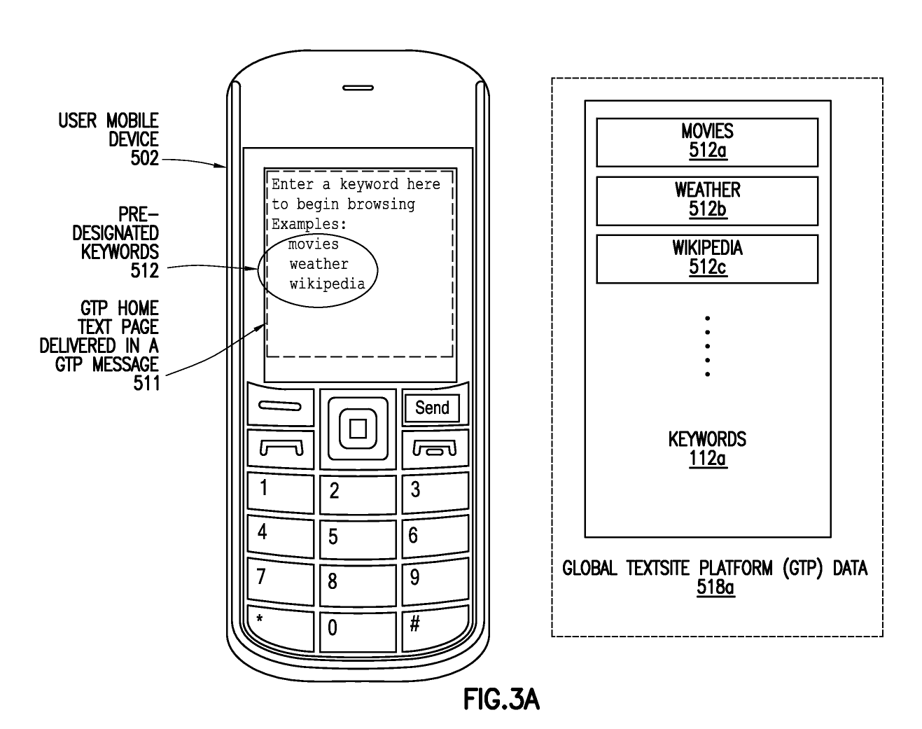

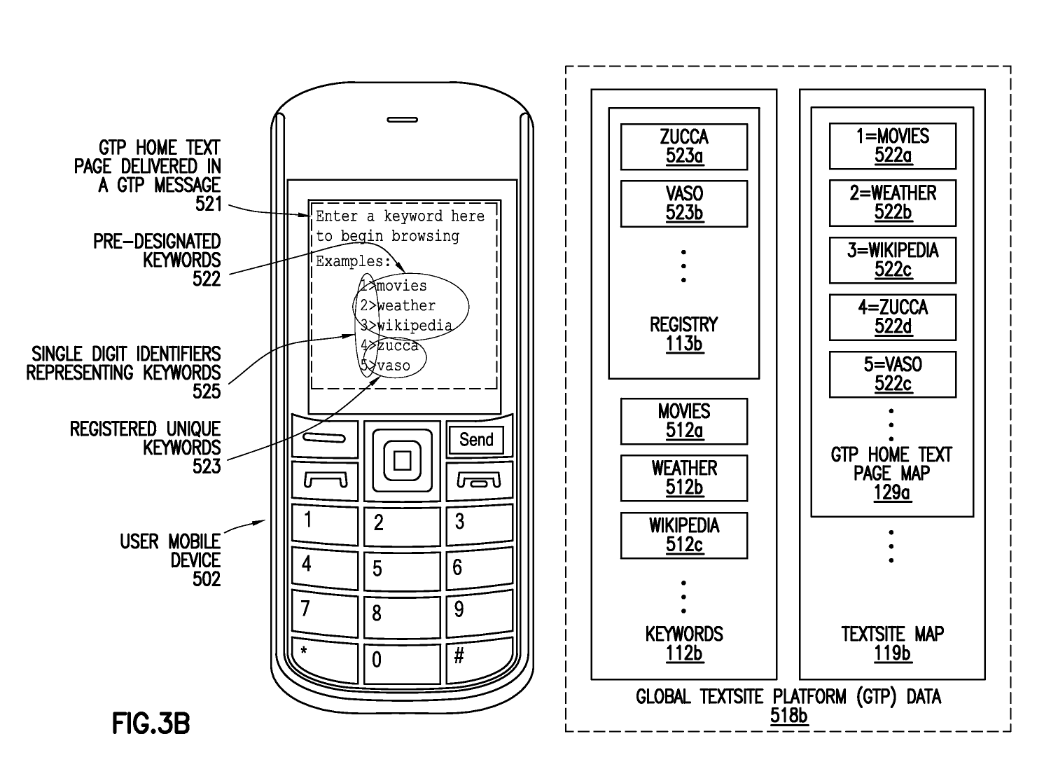

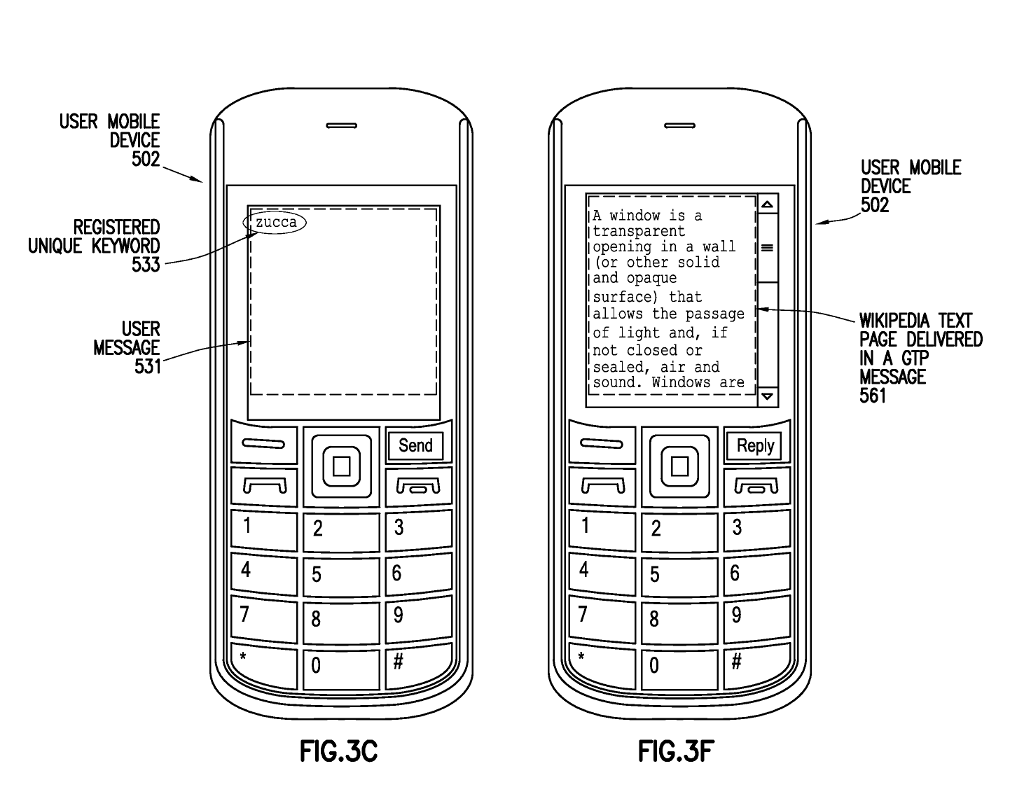

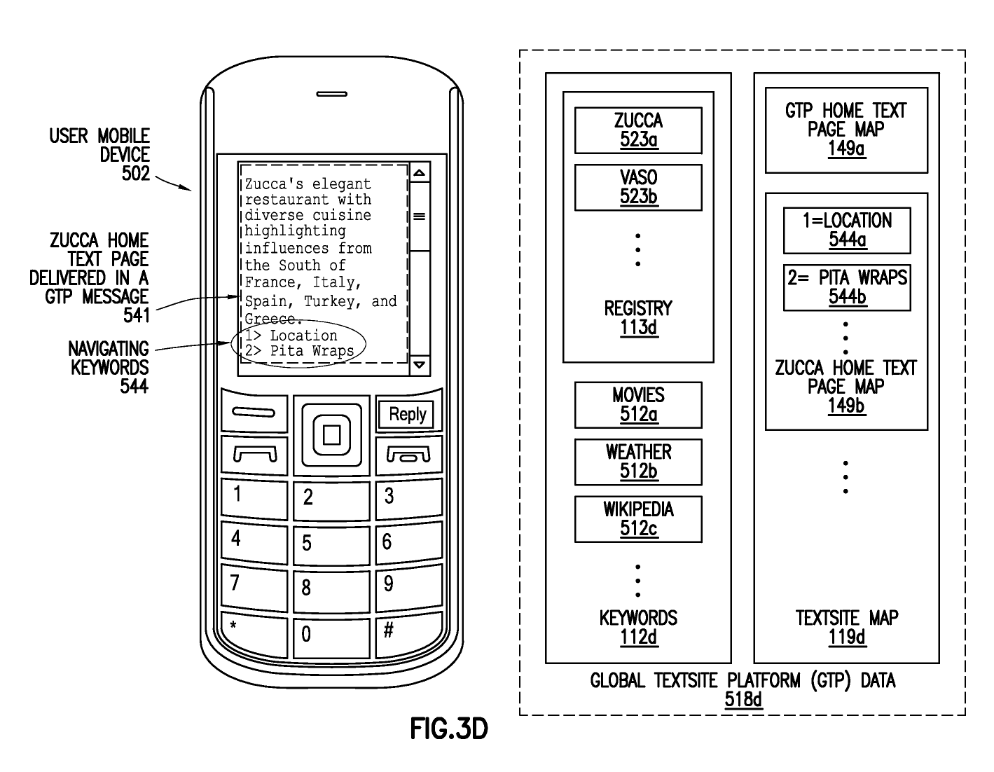

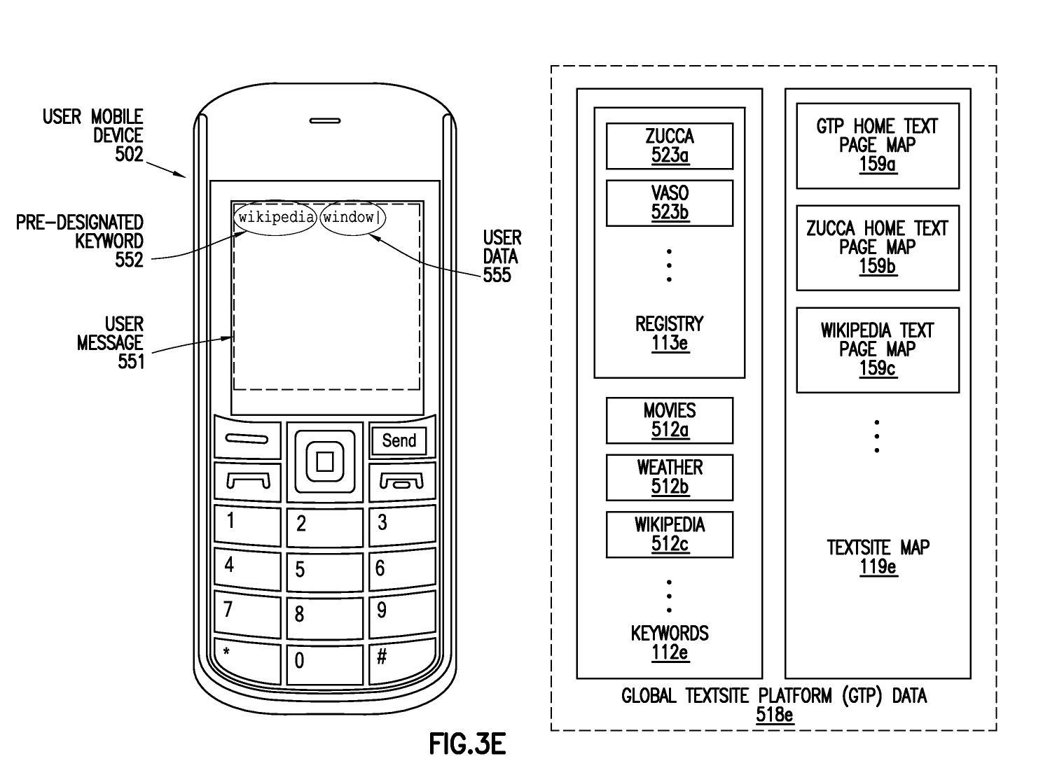

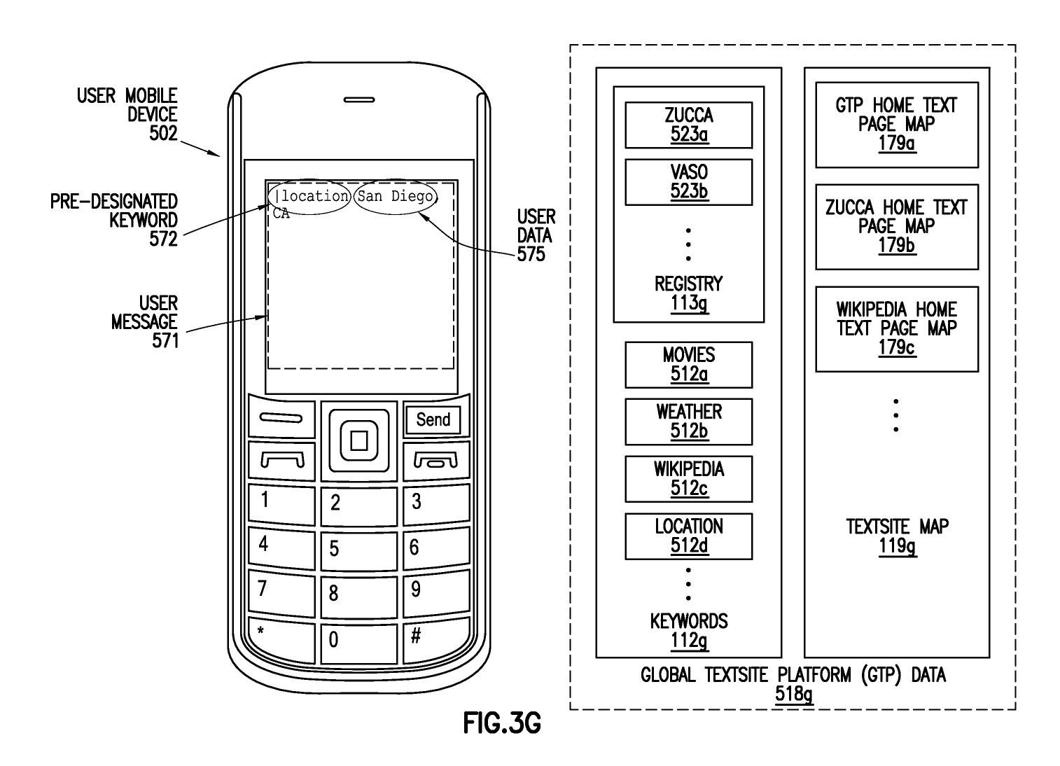

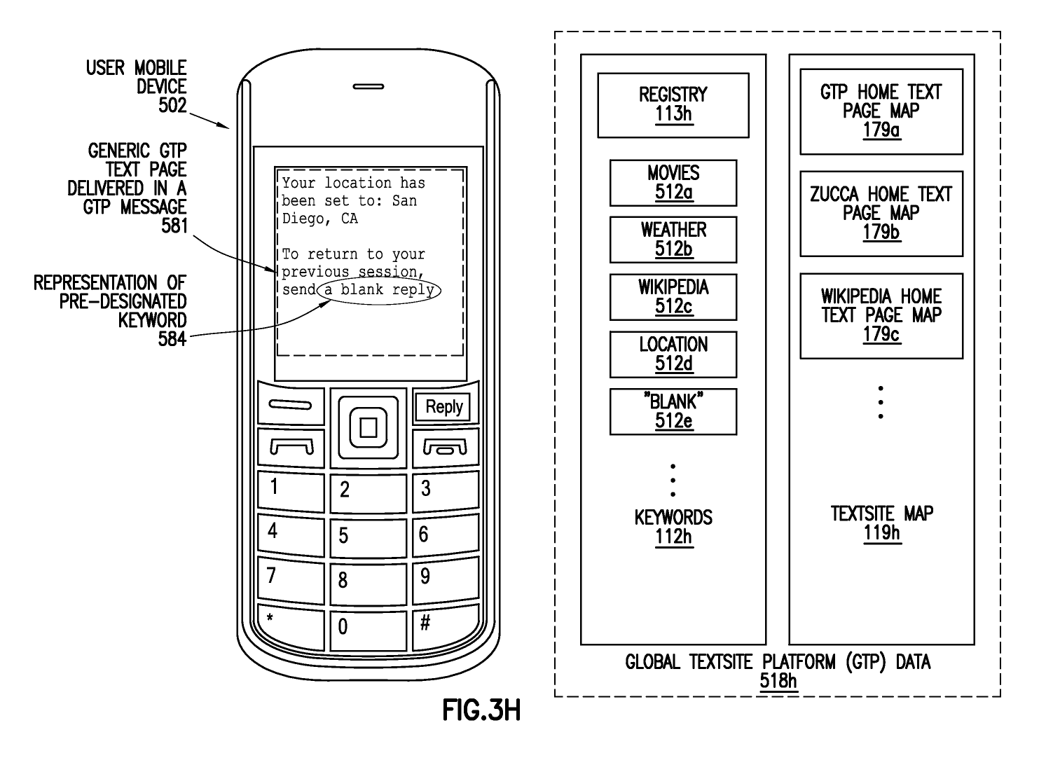

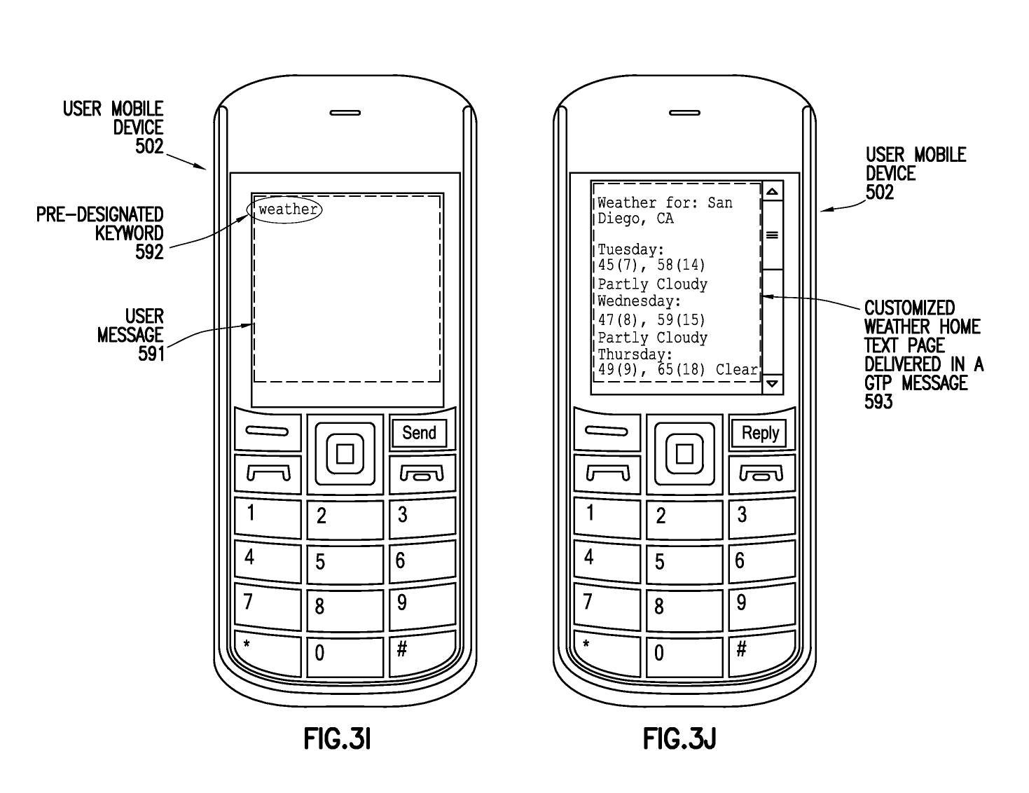

In one or more embodiments of the invention, the agent (115) is configured to identify, based on the registry (113), a registered unique keyword (i.e., used as site identifier) in the user message as a request to access the textsite (118a) hosted on the global textsite platform (108) or the textsite (128a) hosted on the third party server (126a). Accordingly, the agent (115) is configured to access the textsite (118a) or the textsite (128a) using the aforementioned access path included in the associated metadata. In one or more embodiments, the agent (115) is configured to exchange text messages with the user mobile device (102) for navigating a text page hierarchy of the textsite (118a) or the textsite (128a). In one or more embodiments, the textsite (118a) and the textsite (128a) include textsite map (119) and textsite map (129), respectively, that describe the hierarchical relationships of text pages contained within each textsite (118a, 128). For example, the textsite map (119) and the textsite map (129) may each include a data structure (e.g., graph, tree, linked list, file, database, etc.) containing navigating keywords defined by the respective publisher. Generally speaking, navigating keyword information (e.g., access information such as location, address, or other information enabling access to a text page pointed to by a navigating keyword) and navigation paths among text pages in the textsite (e.g., textsite (118a)) are stored in the textsite map (e.g., textsite map (129)). Specifically, a navigation path leads from one text page to another via intervening text pages accessed using the navigating keywords contained in each of the text pages traversed along the navigation path. More details of navigating a textsite, for example based on the textsite map, by exchanging text messages between the agent (115) and the user mobile device (102), are described in reference to FIGS. 3A, 3B, 3C, 3D, 3F, 3G, 3H, 3I, and 3J below.

In one or more embodiments of the invention, the agent (115) is configured to identify, based on the registry (113), a registered unique keyword (i.e., used as site identifier) in the user message as a request to access the website (138) hosted on the web server (136). For example, such registered unique keyword may be registered by a publisher of an adaptor plug-in that maps the website map (139) into a global textsite platform syntax suitable for the adaptor (120) to convert contents of the website (138). Accordingly, the agent (115) is configured to activate the adaptor (120) for accessing the website (138) using the aforementioned access path included in the associated metadata. In one or more embodiments, the agent (115) is configured to exchange text messages with the user mobile device (102) and convert between such text messages in the global textsite platform syntax (e.g., navigating keywords) and the website map (139) for navigating a website document hierarchy of the website (138). For example, the mapping between such navigating keywords and the website map (139) may be contained in an adaptor plug-in for the website (138) where the navigating keywords are defined by the publisher of the adaptor plug-in.

In one or more embodiments of the invention, the agent (115) is configured to identify a web URL (i.e., used as website identifier in Universal Resource Locator format) in the user message as a request to access the website (138) hosted on the web server (136). Accordingly, the agent (115) is configured to activate the adaptor (120) for accessing the website (138) using the identified web URL via the Internet (126). The subsequent navigation of the website (138) may be essentially the same as described above.

In one or more embodiments of the invention, the textsite (118a), the textsite (128a), and/or the website (138) are configured to integrate contents from each other. In such embodiments, the textsite map (119), the textsite map (129), and/or the website map (139) are configured to include registered unique keywords (i.e., used as site identifiers) of other textsites and/or websites, which may be included in user text messages for redirecting the user mobile device (102) from one site (e.g., one of the textsite (118a), the textsite (128a), and the website (138)) to another during navigation of textsite content or converted website content.

In one or more embodiments of the invention, the aforementioned text messages exchanged between the user mobile device (102) and the global textsite platform (108), and more specifically between the user mobile device (102) and the agent (115), are of the same TMS protocol. Alternatively, text messages exchanged may include more than one TMS protocol. For example, the user messages may be SMS and the GTP messages may be MMS. Additional combinations are also possible in other examples.

Although the description above uses the user mobile device (102) in various example embodiments, those skilled in the art will appreciate that similar functionalities may be achieved by substituting the user mobile device (102) with the computing device (128). Further, the aforementioned redirecting functionality may be adapted to allow browsing of website (138) using the computing device (128) to be redirected to accessing a textsite (e.g., textsite (118a) or textsite (128a)) using the user mobile device (102) and vice-versa.

Although the GTP data (e.g., keywords, registry, textsite map, etc.) shown in FIG. 1B above are described in specific formats and organizations, those skilled in the art with the benefit of this disclosure will recognize that GTP data may be in other formats or organizations without deviating from the spirit of the invention.

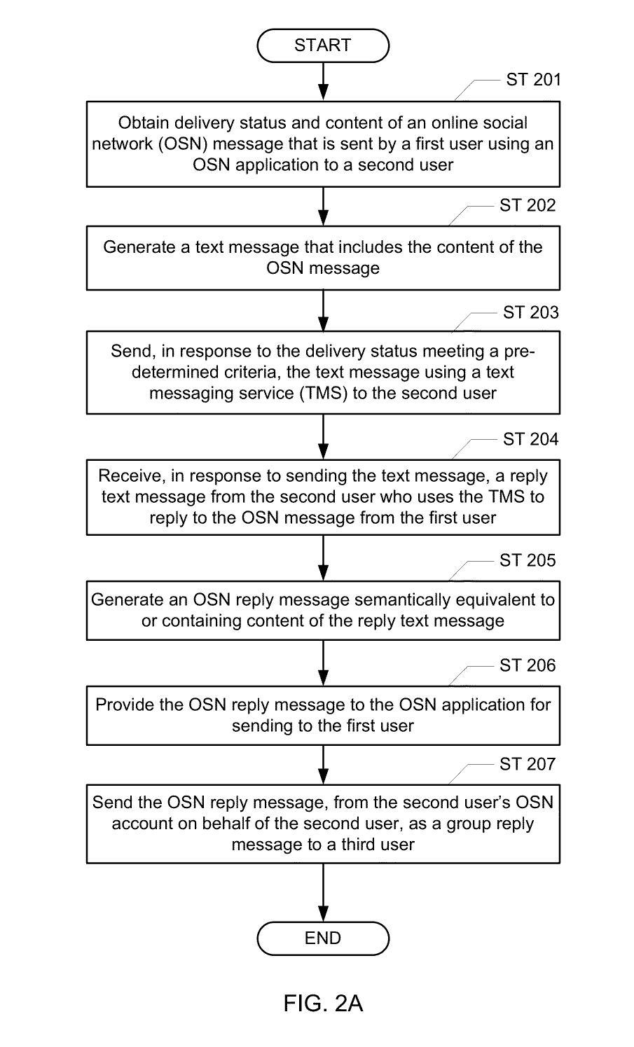

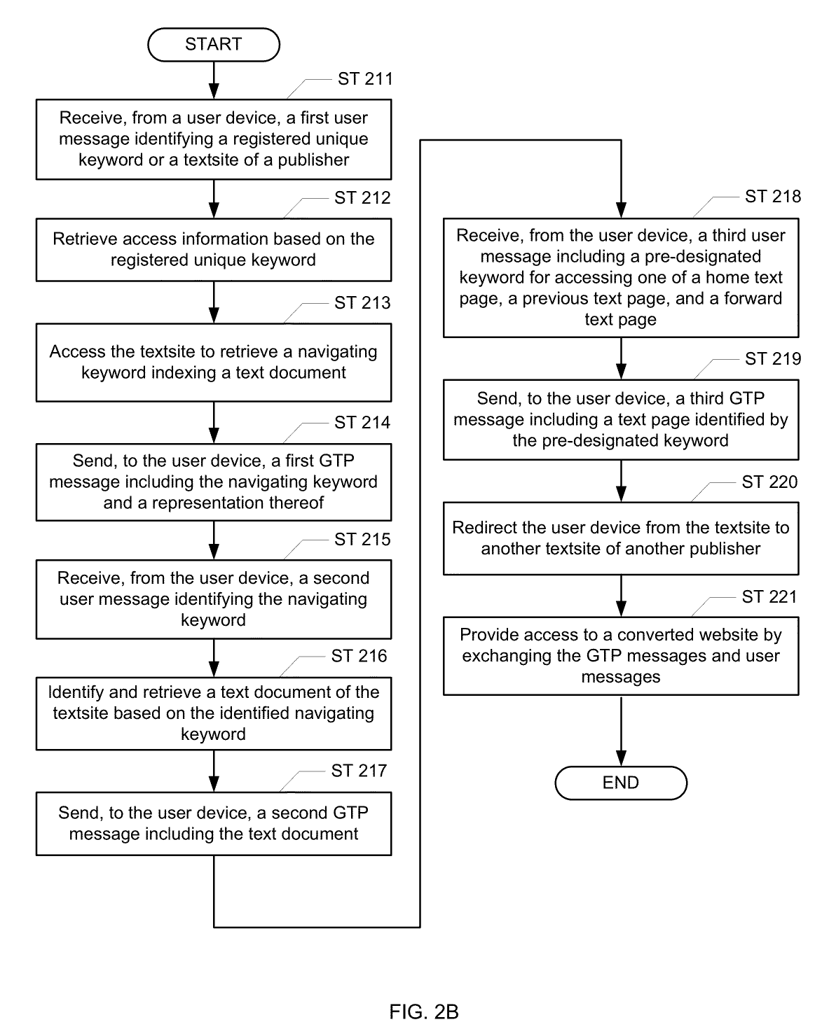

FIG. 2A shows a flow chart for personalized bookmarking of textsite applications of a text messaging service (TMS) based content platform in accordance with one or more embodiments of the invention. In one or more embodiments of the invention, the TMS based content platform may be the global textsite platform (GTP) described in reference to FIG. 1B above. In one or more embodiments of the invention, the method of FIG. 2A may be practiced using the system (100a) described in reference to FIG. 1A above. In one or more embodiments of the invention, one or more of the steps shown in FIG. 2A may be omitted, repeated, and/or performed in a different order than that shown in FIG. 2A. Accordingly, the specific arrangement of steps shown in FIG. 2 should not be construed as limiting the scope of the invention.

Initially in Step 201, information regarding an OSN message is obtained. Specifically, the OSN message is sent by a first user to a second user using an OSN application. In particular, the OSN application is accessed by the first user and the second user under their respective OSN accounts based on respective network data services (i.e., data plans) subscribed by the first user and the second user. In one or more embodiments, the information regarding the OSN message includes message delivery status and message content that are obtained via an application programming interface of the OSN application. In one or more embodiments, the delivery status includes an indication whether the OSN message has been delivered, whether the message recipient (i.e., the second user) has viewed the OSN message, and/or whether the message recipient (i.e., the second user) is offline from his/her subscribed network data service and not able to view the OSN message using the OSN application.

In Step 202, a TMS message that is semantically equivalent to the OSN message is generated, when the second user (i.e., the recipient of the OSN message) has not or cannot view the OSN message directly using the OSN application. Specifically, the delivery status is checked against pre-determined criteria. In one or more embodiments, the pre-determined criteria includes the indication that the second user has not viewed the OSN message within a pre-determined time period since the OSN message was sent by the first user using the OSN application. In one or more embodiments, the pre-determined criteria includes the indication that the second user has not viewed the OSN message within a pre-determined time period since the OSN message was delivered to the second user's OSN account within the OSN application. In one or more embodiments, the pre-determined criteria includes an indication that the second user is offline from his/her subscribed network data service and is not able to view the OSN message using the OSN application.

In response to determining that the message delivery status meets the pre-determined criteria, the TMS message is generated based on the message content of the OSN message. In one or more embodiments, the TMS message is semantically equivalent to the OSN message.

In Step 203, the TMS message is sent using a text messaging service (TMS) to the intended recipient (i.e., the second user). For example, the TMS message is sent to the second user based on the second user's phone number stored in the second user's OSN account. In one or more embodiments, the TMS message and the phone number are provided to a TMS based content platform (e.g., the aforementioned GTP) for sending to the second user as a GTP message. Accordingly, the second user receives and views this GTP message as a semantically equivalent version of the OSN message without using any Internet data plan. Detailed examples of sending and receiving GTP messages without using Internet data plan are described in reference to FIGS. 1B, 2B, and FIGS. 3A, 3B, 3C, 3D, 3E, 3F, 3G, 3H, 3I, and 3J below.

In Step 204, in response to sending the text message, a reply text message is received from the second user who uses the TMS to reply to the OSN message from the first user. In one or more embodiments, the reply text message is received via the GTP as a reply GTP message from the second user. In Step 205, an OSN reply message semantically equivalent to (or containing content of) the reply text message is generated. In Step 206, this OSN reply message is provided to the OSN application for sending to the first user. Although the second user is offline and cannot access the OSN application directly, the OSN reply message is sent to the first user from the second user's OSN account on behalf of the second user.

In one or more embodiments, the OSN message is a group chat message and has multiple recipients, including the second user and an additional third user. In such embodiments, the OSN reply message is a group reply message and is also sent to the third user from the second user's OSN account on behalf of the second user. (Step 207)

In summary as described above, the OSN message is converted into a GTP message for sending to an offline message recipient while the OSN reply message is converted from a GTP reply message returned by the offline message recipient. The method of sending and receiving GTP message and GTP reply message is described in reference to FIG. 2B below. More specifically, FIG. 2B shows a flow chart for accessing content of one or more textsites in accordance with one or more embodiments of the invention. In one or more embodiments of the invention, the method of FIG. 2B may be practiced using the GTP described in reference to FIG. 1B above. In one or more embodiments of the invention, one or more of the steps shown in FIG. 2B may be omitted, repeated, and/or performed in a different order than that shown in FIG. 2B. Accordingly, the specific arrangement of steps shown in FIG. 2B should not be construed as limiting the scope of the invention.

Initially in ST 211, a first user message is received, from a user mobile device that identifies a registered unique keyword maintained by the GTP. As described above, the registered unique keyword may be registered with the GTP by a publisher of a textsite identified by the registered unique keyword while the user device may be a mobile phone or other computing devices. By sending the registered unique keyword in the first user message, the user is requesting access to (i.e., to browse) the textsite associated with the registered unique keyword. In one or more embodiments of the invention, the GTP and/or the publisher may distribute an advertisement containing the registered unique keyword in a commercial promotion. Accordingly, the user may obtain the registered unique keyword from the advertisement. Alternatively, in one or more embodiments of the invention, the GTP may send, in response to receiving a request from the user device, a GTP message identifying a number of sample registered unique keywords from which the user may select a particular one to be included in the first user message. For example, the sample registered unique keywords may be registered with the GTP by a number of different publishers. In one or more embodiments, the request for a listing of registered unique keywords may be received from the user device in a second user message containing a pre-designated keyword defined specifically for requesting such a listing. Alternatively, in one or more embodiments, the user may request such a listing by simply making a conversationless call to the phone number of the GTP instead of sending the second user message to the same phone number. Using any of the approaches described above, the user may obtain a list of textsites accessible via the GTP using a single phone number (e.g., a local phone number) provided by the GTP according to a geographical location of the user. Accordingly, the user is not required to separately obtain and keep different phone numbers for accessing different textsites using a TMS.

In ST 212, authored content (e.g., access information) associated with the textsite requested by the user is retrieved based on the registered unique keyword extracted from the first user message received at the GTP. In one or more embodiments of the invention, the GTP maintains a registry containing an entry for each registered unique keyword that holds pertinent information of the textsite such as location, network address, access path, and other suitable metadata associated with the textsite. Accordingly, the access information associated with the user requested textsite may be retrieved. For example, such access information may determine whether the requested textsite is hosted on a server of the GTP or a third party server separate from the GTP.

In ST 213, the textsite is accessed based on the retrieved authored content (e.g., access information) to retrieve a navigating keyword. For example, a portion of the navigating keywords of the textsite may be retrieved. In another example, the navigating keyword may be retrieved by retrieving a home text page from the textsite that contains the navigating keyword. Generally speaking, the navigating keyword may be an alphanumeric string (e.g., location, Pita Wraps, Panini, Entrees, etc.) that is meaningful to the user but requires many keys to enter into the user device while the other navigating keyword may be a short string (e.g., loc, PW, P, E, 1, 2, 3, etc.) that is easy to enter but less meaningful to the user for selection. To assist the user in selecting a navigating keyword from a GTP message and to key in the selected navigating keyword when composing a reply user message, a cryptic navigating keyword (e.g., loc, PW, P, E, 1, 2, 3, etc.) may be associated with a meaningful label (e.g., location, Pita Wraps, Panini, Entry, etc.) and displayed together (e.g., loc>location, PW>Pita Wraps, P>Panini, E>Entrees, 1>location, 2>Pita Wraps, 3>Panini, etc.) in the text page delivered via the GTP message. Similarly, a meaningful navigating keyword (e.g., location, Pita Wraps, Panini, Entry, etc.) may be associated with a short hand identifier (e.g., loc, PW, P, E, 1, 2, 3, etc.) and displayed together (e.g., loc>location, PW>Pita Wraps, P>Panini, E>Entrees, 1>location, 2>Pita Wraps, 3>Panini, etc.) in the text page delivered via the GTP message. The meaningful label and the short hand identifier are referred to as a representation of the navigating keyword. In one or more embodiments, representations of the navigating keyword may also include formats different from the meaningful label and/or the short hand identifier.

In ST 214, a first GTP message containing the retrieved navigating keyword is sent to the user device in response to receiving the first user message. In one or more embodiments, the first GTP message includes the retrieved portion of the textsite navigating keywords. In one or more embodiments, the first GTP message includes the text page containing the retrieved navigating keyword. For example, the home text page of the textsite may be sent to the user device in the first GTP message as a reply to the first user message containing the registered unique keyword. Accordingly, the user may access a desired text page from the home text page by selecting a corresponding navigating keyword contained in the home text page. In one or more embodiments, a text page also contains, as defined by the publisher, representations of included navigating keywords for ease of user selection. For example, each of the navigating keywords in the home text page sent in the first GDP message may be accompanied by a meaningful label or a short hand identifier. Accordingly, the user may specify (or identify) a desired text page by including either a corresponding navigating keyword or a representation of such navigating keyword in a second user message replying to the first GTP message. In ST215, this second user message is received at the GTP.

As noted above, navigating keyword information (e.g., access information such as location, address, or other information enabling access to a text page pointed to by a navigating keyword) and navigation paths to text pages in the textsite are stored in the textsite map. In one or more embodiments of the invention, information regarding meaningful labels, short hand identifiers, or other keyword representations for a navigating keyword in a text page is also included in the textsite map. For example, such information includes the aforementioned dynamically assigned link and dynamically assigned keyword identifier described in reference to FIGS. 1A and 2A above. In ST 216, the desired text page is identified according to the textsite map based on either the navigating keyword or a representation (e.g., a meaningful label, short hand identifier) thereof extracted from the second user message. Further, the desired text page is retrieved by looking up access information in the textsite map accordingly.

In ST 217, the desired text page is included in a second GTP message and sent, as reply to the second user message, to the device for display to the user.

In ST 218, a third user message is received from the device while displaying the first text page. The third user message includes a pre-designated keyword (e.g., “,” “0,” “.,” etc.). For example, the pre-designated keyword may be defined specifically for accessing a home text page of the textsite. In response, the GTP sends the home text page to the device in a third GTP message (ST 219). In another example, the pre-designated keyword may be defined specifically for accessing a previous text page sent to the device prior to the text page in a navigation trace. An example navigation trace is described with reference to FIGS. 3A-3J below. In response, the GTP sends the previous text page to the device in the third GTP message (ST 219). In still another example, the pre-designated keyword may be defined specifically for accessing a forward text page sent to the device subsequent to the text page in the navigation trace. In response, the GTP sends the forward text page to the device in a third GTP message (ST 219). In yet another example, the pre-designated keyword may be defined specifically for subscribing to updates of a currently displayed text page. In response, the GTP sends updated versions of the currently displayed text page in a push mode to the device from time to time in recurring GTP messages (ST 219).

While the description above regarding ST 211 through ST 219 relates to a textsite published by a publisher under a registered unique keyword, the user may obtain another registered unique keyword separately registered with the GTP by another publisher of another textsite. During navigation of the currently displayed textsite, a user message may be received identifying a second registered unique keyword. For example, such user message may include either the second registered unique keyword or a representation thereof. In response, the GTP redirects the user device from the currently navigated textsite to the second textsite (ST 220). Accordingly, the GTP may exchange text messages with the device for navigating the second textsite using a second set of navigating keywords according to a second textsite map of the second textsite. Accordingly, in one or more embodiments, the user may switch back and forth between different textsites published by different publishers without the need to change the phone number to which the text messages are sent in the middle of the textsite navigation.

As described above, there are several different approaches as to how a user may obtain a list of all textsites accessible via the GTP regardless of which publisher authored the content. An additional scenario in which the user may obtain additional registered unique keywords is from a text page having an embedded external link, as authored by the publisher and is consistent with the textsite map. In this scenario, a user message may be redirected to a second or third textsite as described above. Further, the text page may include a short hand identifier for the embedded external link in which case the user message may just include the short hand identifier for quick redirection.

In some scenarios, the second textsite described above is converted from a website, for example, using the adaptor described in reference to FIG. 1B above. In such scenarios, the second navigating keyword may be registered for the website where a corresponding registry entry specifies a particular adaptor plug-in for use to map between a website map of the website and a textsite map converted from the website map. Specifically, a navigating keyword received in a user message during navigation of the converted website is processed using the textsite map, the adaptor plug-in, and the website map to retrieve access information associated with a corresponding webpage. Subsequently, the webpage may be retrieved and converted dynamically (i.e., on demand) into a text page for sending to the user device. Alternatively, a pre-converted text page may be stored and retrieved for sending to the user device (ST 221).

Examples of screenshots detailing what a user text message and a response from the global textsite platform may look like are described in reference to FIGS. 3A, 3B, 3C, 3D, 3E, 3F, 3G, 3H, 3I, and 3J below.

FIGS. 3A, 3B, 3C, 3D, 3E, 3F, 3G, 3H, 3I, and 3J show various screenshots illustrating examples of accessing content hosted by a global textsite platform in one or more embodiments of the invention. Although FIGS. 3A, 3B, 3C, 3D, 3E, 3F, 3G, 3H, 3I, and 3J show implementation examples of embodiments of the invention, those skilled in the art will appreciate that there may be other ways in which to implement embodiments of the invention, and that the example screenshots are not meant to limit the scope of the invention. Throughout FIGS. 3A, 3B, 3C, 3D, 3E, 3F, 3G, 3H, 3I, and 3J, a text page delivered in a GTP message and the GTP message delivering the text page may both be referred to using the same reference numerals.

FIG. 3A shows the user mobile device (502) displaying an example GTP home text page, which is delivered via TMS in a GTP message (511). As noted above, this GTP home text page may be sent in the GTP message (511) in response to a request from a user. For example, the user may send a request message in a pre-designated format (e.g., with blank content or with content associated with another pre-designated keyword) using a phone number of the GTP to request the GTP home text page. In another example, the user may have made a conversationless telephone call to the phone number of the GTP to request the GTP home text page. As shown in FIG. 3A, the GTP home text page includes pre-designated keywords (512) listed as movies, weather, and Wikipedia. For example, these pre-designated keywords are stored in the keywords (112a) of GTP data (518a) corresponding to the keywords (112) shown in FIG. 1B above. The keywords (112a) includes pre-designated keyword entries of movies (512a), weather (512b), and Wikipedia (512c) corresponding to sample textsites or generic textsites included in and/or hosted by the GTP.

FIG. 3B shows the user mobile device (502) displaying another example GTP home text page delivered in a GTP message (521), which may be requested and delivered in essentially the same way as the example GTP home text page described in reference to FIG. 3A above. In the example GTP home text page shown in FIG. 3B, the pre-designated keywords (522) are essentially the same as the pre-designated keywords (512) described above while followed by registered unique keywords (523) listed as zucca and vaso. Accordingly, keywords (112b) of the GTP data (518b) include a registry (113b) in addition to the pre-designated keyword entries movies (512a), weather (512b), and wikipedia (512c). As shown, the registry (113b) includes keyword entries zucca (523a) and vaso (523b), which are linked to access information (not shown) to the respective textsites associated with those keywords.

Further as shown in FIG. 3B, short hand identifiers (525) (i.e., 1, 2, 3, 4, and 5) are displayed next to and represent pre-designated keywords (522) and registered unique keywords (523) for user selection in the example GTP home text page delivered in the GTP message (521). For example, zucca and vaso of the registered unique keywords (523) correspond to a restaurant textsite and a bookstore textsite, respectively. As described above, the user may include either the keyword “zucca” or the corresponding short hand identifier “4” when replying to the GTP message (521) to access the restaurant textsite. To facilitate this, a textsite map (119b) of the GTP data (518b) includes GTP home text page map (129a) containing entries (e.g., entry (522a) through entry (522e), etc.) for describing representations of the keywords using the short hand identifiers (525) and for describing access information authored for the respective textsites.

As described above, the registered unique keywords zucca and vaso may be registered with the GTP by the respective restaurant and bookstore owners who created their own textsites or registered by contracted publishers on their behalf. Further, the zucca textsite may be hosted on a server of the GTP while the vaso textsite may be hosted on a third party server separate from the GTP.

FIG. 3C shows the user mobile device (502) displaying an example user message (531) containing the registered unique keyword (533) (i.e., zucca) as selected by the user from the example GTP home text page shown in FIG. 3B above. Alternatively, the registered unique keyword (533) may be obtained by the user from an advertisement distributed, for example, by restaurant zucca in a commercial promotion.

FIG. 3D shows the user mobile device (502) displaying an example home text page of the textsite for restaurant Zucca, which is delivered in a GTP message (541) in response to the user message (531) described above. As shown, the example zucca home text page includes navigating keywords and representations thereof (544) listed as “1>location” and “2>pita wraps.” For example, “1” may be considered the navigating keyword while “location” is the meaningful label. Alternatively, “location” may be considered the navigating keyword while “1” is the short hand identifier. In either case, the aforementioned navigating keywords and representations thereof are displayed together for user selection in the zucca home text page. In the example shown in FIG. 3D, the GTP data (518d) is essentially the same as the GTP data (518b) shown in FIG. 3B above with an additional zucca home text page map (e.g., entry (544a), entry (544b), etc.) included in the textsite map (119d). For example, the GTP home text page map (149a) is essentially the same as the GTP home text page map (129a) shown in FIG. 3B above. As described above, the zucca home text page map (149b) contains entries for describing representations of the navigating keywords using the meaningful labels or short hand identifiers within the zucca home text page and for describing access information for respective text pages referenced by the navigating keywords. For example, including either the navigating keyword or the corresponding representation (i.e., either one of “location” or “1”) in a user message replying to the GTP message (541) results in a text page containing address and driving direction information of the zucca restaurant being identified by the GTP. The address and driving direction information (i.e., the authored content for the text page associated with the navigating keyword (i.e., “location” or “1”) is then delivered to the user mobile device (502) in a subsequent GTP message. As described above, the representation of navigating keywords (544) using meaningful labels or short hand identifiers and the use of navigating keywords (544) to index the respective text pages are applicable only within the displayed text page, which is the zucca home text page, in this instance. Said another way, and as illustrated in FIGS. 3G and 3H below, the keyword “location” or “1” may be associated with different effects when used in a context other than replying to a GTP message delivering the zucca home text page.

FIG. 3E shows the user mobile device (502) displaying an example user message (551) containing the pre-designated keyword (552) (i.e., Wikipedia) as selected by the user from the example GTP home text page shown in FIG. 3B above or otherwise obtained by the user from an advertisement distributed, for example, by an operator of the GTP promoting built-in features of the GTP. As shown in FIG. 3E, the pre-designated keyword (552) (i.e., Wikipedia) is followed by user data (555) (i.e., “window”) in the user message (551) to initiate a search for information relating to user data (555) (i.e., “window”) within the Wikipedia textsite. To facilitate this, textsite map (119e) of the GTP data (518e) includes Wikipedia text page map (159c) describing relevant syntax information applicable to the Wikipedia textsite. For example, the Wikipedia text page map (159c) may relate to a home text page or a text page other than the home text page of the Wikipedia textsite. The GTP home text page map (159a) and Zucca home text page map (159b) are essentially the same as the GTP home text page map (149a) and Zucca home text page map (149b) shown in FIG. 3D above.

FIG. 3F shows the user mobile device (502) displaying an example wikipedia text page delivered in a GTP message (561) responding to the user message (531) described above. As shown, the example wikipedia text page contains search result relating to the user data (555) (i.e., “window”).

FIG. 3G shows the user mobile device (502) displaying an example user message (571) containing the pre-designated keyword (572) (i.e., location, as reflected by the entry location (512d) in keywords (112g) of the GTP data (518g)), for example obtained by the user in a GTP user guide (e.g., online user guide). As shown in FIG. 3E, the pre-designated keyword (572) (i.e., location) is followed by user data (575) (i.e., “San Diego”) in the user message (571) to set a global user location parameter throughout the GTP. Accordingly, for example and as described in FIGS. 3I and 3J below, a textsite registered with the GTP may utilize this global user location parameter set by the user for performing related activities, such as searching for weather information associated with the user location reflected in this global user location parameter. In another example, the textsite may overwrite this global user location parameter by a locally defined location keyword, as described in FIG. 3D above. The GTP home text page map (179a), Zucca home text page map (179b), and Wikipedia home text page map (179c) are essentially the same as the GTP home text page map (159a), Zucca home text page map (159b), and Wikipedia home text page map (159c) shown in FIG. 3E above.

FIG. 3H shows the user mobile device (502) displaying an example GTP text page delivered in a GTP message (581) responding to the user message (571) described above. As shown, the example GTP text page contains confirmation to the user data (575) (i.e., “San Diego”) and navigating tips describing a pre-designated keyword “ ” represented by the word “blank” (584) as reflected by the entry “blank” (512e) in keywords (112h) of the GTP data (518h). Based on the displayed navigating tips, the GTP may identify a previous session (e.g., a previous text page) from a user navigation trace for delivering to the user mobile device (502) upon receiving a user message containing the pre-designated keyword “ ” represented by the word “blank” (584). An example user navigation trace is the sequence of textsites traversed by the user as illustrated in FIGS. 3A through 3G above, which may be tracked by the GTP for assisting user textsite navigation. Other examples of pre-designated navigating keywords or syntax associated with the GTP may include a globally reserved single text digit (e.g., “0”) or text string (e.g., “.”) used for re-directing to a home page of the currently displayed textsite, a forward text page in the user navigation trace, or other pre-defined text pages. Similar to the use of the pre-designated keyword “location” (572), such pre-designated navigating keywords (e.g., “,” “0,” “.,” etc.) may be utilized or overwritten by a textsite based on syntax information defined in a corresponding textsite map by the publisher. The textsite map (119h) is essentially the same as the textsite map (119g) as shown in FIG. 3G above.

FIG. 3I shows the user mobile device (502) displaying an example user message (591) containing the pre-designated keyword (592) (i.e., weather) as selected by the user from the example GTP home text page shown in FIG. 3B above or otherwise obtained by the user from an advertisement distributed, for example, by an operator of the GTP promoting built-in features of the GTP.

FIG. 3J shows the user mobile device (502) displaying an example weather text page maintained by the GTP, which is delivered in a GTP message (593) in response to the user message (591) described above. As shown, the example weather text page illustrate a customized home text page for the weather textsite defined by the global user location parameter described in FIGS. 3G and 3H above.

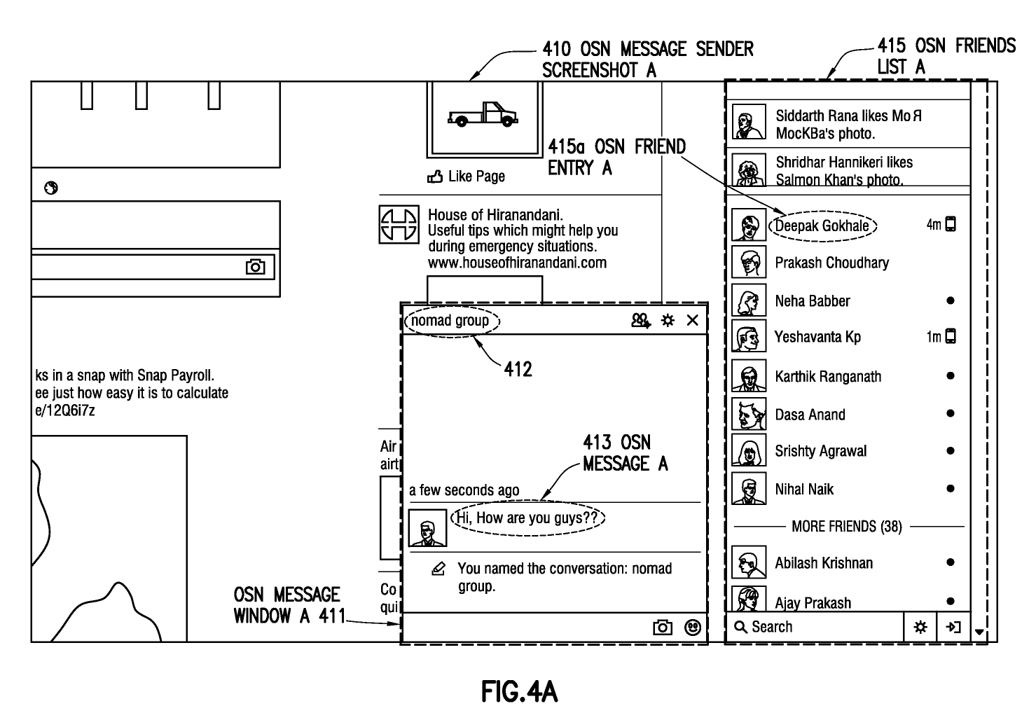

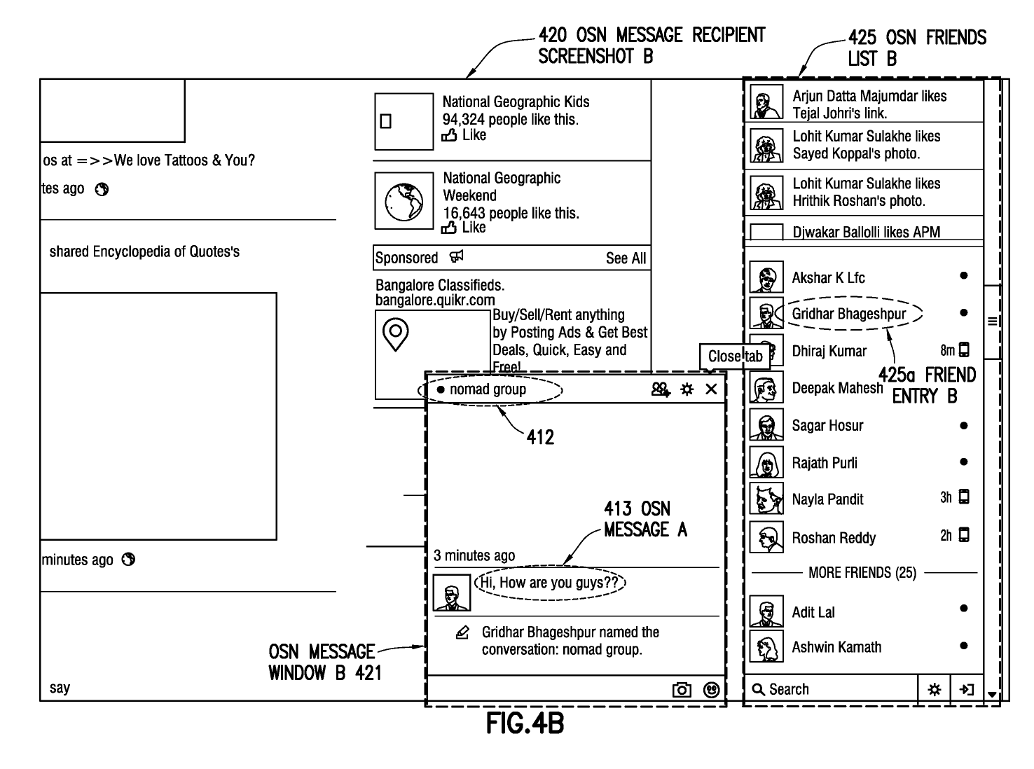

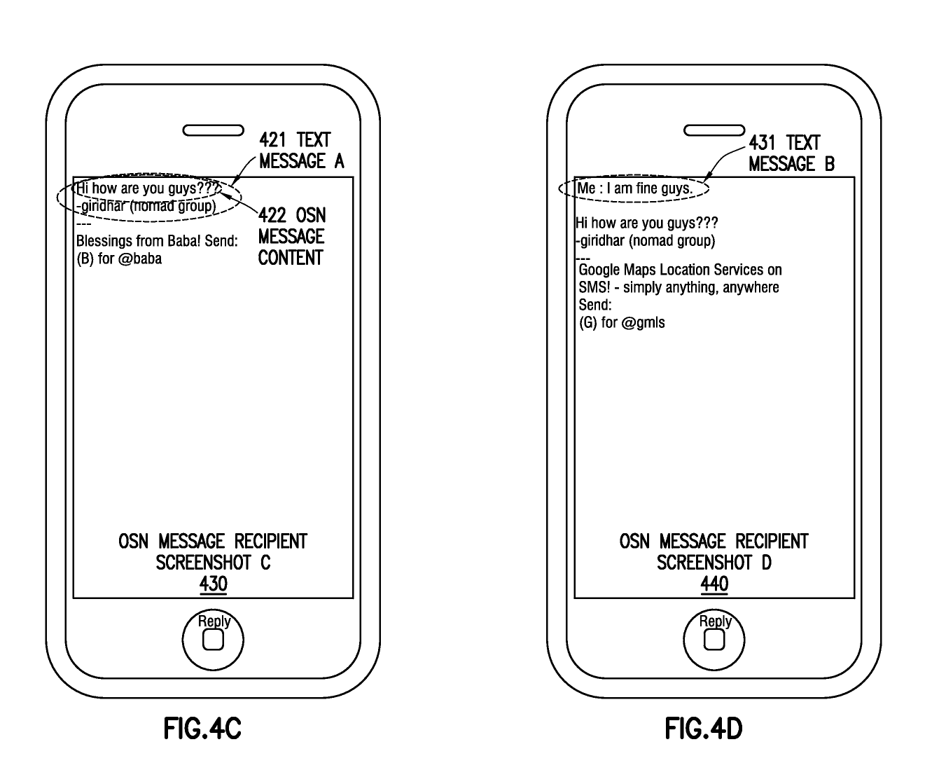

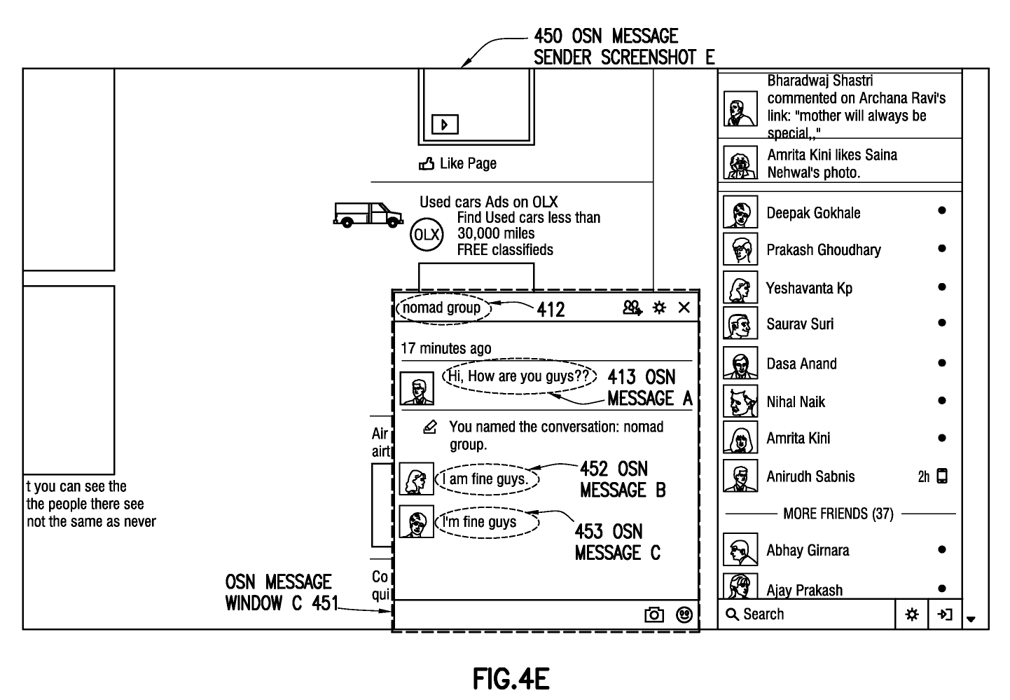

FIGS. 4A, 4B, 4C, 4D, and 4E show an example in accordance with one or more embodiments of the invention. Specifically, the example relates to a scenario of an OSN message sender “Giridhar” exchanging messages with two OSN message recipients “Deepak” and “Yeshwanth.” In one or more embodiments, the example shown in FIGS. 4A, 4B, 4C, 4D, and 4E is based on one or more of the system A (100) and system B (100b) described in reference to FIG. 1A and FIG. 1B, respectively above. In one or more embodiments, the example shown in FIGS. 4A, 4B, 4C, 4D, and 4E is based on one or more of the methods described in reference to FIG. 2A and FIG. 2B above.

FIG. 4A shows an example OSN message sender screenshot A (410), which corresponds to an OSN session logged-in and viewed by the OSN message sender “Giridhar.” In other words, Giridhar is connected to the Internet using his network device (e.g., a desktop computer or notebook computer) to view and otherwise interact with the OSN session. As shown in FIG. 4A, the OSN message sender screenshot A (410) includes an OSN message window A (411) and an OSN friends list A (415) that superimpose a page of the OSN session. In particular, the OSN friends list A (415) shows social network friends of Giridhar, including Deepak who is listed in the OSN friend entry A (415a) and is currently online. In other words, Deepak is also connected to the Internet using his network device. Although not explicitly shown, in one scenario, Yeshwanth may also be an OSN friend of Giridhar but is offline, i.e., disconnected from the Internet. In another scenario, Yeshwanth may not be an OSN user at all. In either scenario, Gridha has named the group of himself, Deepak, and Yeshwanth as the nomad group (412). In particular, Giridhar has sent an OSN message (413) “Hi, How are you guys??” a few seconds ago via the Internet to the nomad group (412), as shown in the OSN message window A (411). The OSN message (413) and subsequent messages exchanged among Giridhar, Deepak, and Yeshwanth are referred to as the conversation “nomad group.”

In the example shown in FIG. 4A, the OSN application is configured with the functionality of the OSN/TMS messaging tool described in reference to FIG. 1A above. In other words, the OSN application is configured with the functionality to detect that Deepak is online and ready to view the OSN message (413). Accordingly, the OSN message (413) is sent to Deepak's network device via the Internet. In addition, the OSN application is also configured with the functionality to detect that Yeshwanth is offline or is not an OSN user at all. Accordingly, the OSN application sends an OSN message relay request to the aforementioned global textsite platform (GTP). The OSN message relay request embeds the content of the OSN message (413) in a TMS message for sending to the GTP. For example, the TMS message may be in the form of @XXXXX <phone number><message content>. In this format, “XXXXX” is a pre-determined keyword reserved for this OSN message relay request, “phone number” is the phone number of Yeshwanth retrieved from Yeshwanth's OSN account profile, and “message content” is the content of the OSN message (413). For example, the TMS message may be @SendFb2Sms <+919986809188><Hi, How are you guys??> where +919986809188 is Yeshwanth's phone number. In response to this TMS message as the OSN message relay request, the GTP sends a relayed TMS message to the Yeshwanth's phone number with the content of the OSN message (413) included. Additional details of the relayed TMS message are described in reference to FIG. 4C below. In particular, the OSN message (413), the relayed TMS message, and the content of the OSN message (413) are shown as the text message A (421), the text message B (431), and the OSN message content (422), respectively in FIG. 4C below.

FIG. 4B shows an example OSN message recipient screenshot B (420), which corresponds to another OSN session logged-in and viewed by the OSN message recipient “Deepak.” In other words, Deepak (also connected to the Internet) uses his network device (e.g., a desktop computer or notebook computer) to view and otherwise interact with another OSN session. As shown in FIG. 4B, the OSN message recipient screenshot B (420) includes an OSN message window B (421) and an OSN friends list B (425) that superimpose a page of another OSN session. In particular, the OSN friends list B (425) shows social network friends of Deepak, including Giridhar who is listed in the OSN friend entry B (425a) and has just sent the OSN message A (413) to the nomad group (412), as shown in the OSN message window B (421). Specifically, the OSN message A (413) is received 3 minutes ago by Deepak's network device via the Internet. The OSN message window B (421) also includes information indicating that Giridhar has named the conversation as the nomad group.

FIG. 4C shows an example OSN message recipient screenshot C (430), which corresponds to a text message window viewed by the OSN message recipient “Yeshwanth” using a smartphone that is disconnected from the Internet. For example, Yeshwanth's smartphone may be at a location with no Internet connection. In another example, Yeshwanth's smartphone may not have any subscribed data plan for connecting to the Internet. As shown in FIG. 4C, the OSN message recipient screenshot C (430) includes a text message A (421) that is converted from the OSN message A (413) by the aforementioned OSN/TMS messaging tool functionality as the relayed TMS message. Specifically, a portion of the OSN message A (413), referred to as the OSN message content (422), is included in the text message A (421). Note that the OSN message content (422) “Hi how are your guys???”, although semantically equivalent to the OSN message A (413), has a different format than the OSN message A (413). For example, the comma in the OSN message A (413) is missing from the OSN message content (422). In addition, the OSN message content (422) has one extra question mark than the OSN message A (413).

In response to viewing the text message A (421), Yeshwanth replies “I am fine guys” using TMS to the nomad group. As a result, the OSN message recipient screenshot C (430) is updated to become the OSN message recipient screenshot D (440) shown in FIG. 4D. Specifically, in addition to displaying the received text message A (421) “Hi how are your guys???”, the OSN message recipient screenshot D (440) also includes the text message B (431) “I am fine guys” that is composed and sent by Yeshwanth. In particular, the text message B (431) is sent to the GTP and relayed to the OSN application to be converted into a surrogate OSN message for sending to the nomad group on behalf of Yeshwanth as a reply to the received text message A (421).

FIG. 4E shows an example OSN message sender screenshot E (450), which is an updated version of the OSN message sender screenshot A (410) viewed by the Giridhar as shown in FIG. 3A above. In particular, the OSN message window A (411) shown in FIG. 3A is now updated to become the OSN message window C (451) in the OSN message sender screenshot E (450). Specifically, in addition to displaying the initial OSN message A (413) sent by Giridhar 17 minutes ago, the OSN message window C (451) also includes the OSN message B (452) “I am fine guys.” The OSN message B (452) is the surrogate OSN message converted from the text message B (431) shown in FIG. 4C, as sent by the GTP on behalf of Yeshwanth. Further, the OSN message window C (451) also includes the OSN message C (453) “I;m fine guys” that is replied by Deepak and received from Deepak's network device. Note that OSN message C (453) actually includes a typographical error made by Deepak.

If Deepak goes offline at this point, he will continue to group chat by switching from using the OSN application to using TMS. However, Deepak may not be able to see the previous chat history that he saw in the OSN session.

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 5, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for delivering an online social network (OSN) message, comprising:
obtaining delivery status and content of the OSN message, wherein the OSN message is sent by a first user using an OSN application to a second user;
generating, by a computer processor, a text message comprising the content of the OSN message; and
sending, by the computer processor and in response to the delivery status meeting a pre-determined criteria, the text message using a text messaging service (TMS) to the second user,
wherein the OSN application is used by the first user to exchange social interaction messages with OSN friends of the first user, and
wherein the second user is not able to view the OSN message using the OSN application.

2. The method of claim 1,
wherein the delivery status comprises an indication that the second user has not viewed the OSN message within a pre-determined time period since the OSN message was sent by the first user using the OSN application.

3. The method of claim 1,
wherein the OSN application is accessed by the second user based on a network data service subscribed by the second user, and
wherein the second user receives and views the text message using the TMS separate from the network data service.

4. The method of claim 3,
wherein the delivery status comprises an indication that the second user is offline from the network data service and is not able to view the OSN message using the OSN application.

5. The method of claim 1,
wherein the delivery status and the content are obtained via an application programming interface of the OSN application.

6. The method of claim 1, further comprising:
receiving, in response to sending the text message, a reply text message from the second user, wherein the second user sends the reply text message using the TMS to reply to the OSN message from the first user; and
generating an OSN reply message comprising content of the reply text message; and
sending the OSN reply message using the OSN application to the first user.

7. The method of claim 1, further comprising:
sending the OSN reply message using the OSN application to a third user of the OSN application,
wherein the OSN message is a group message having the second user and the third user as recipients.

8. A system for delivering an online social network (OSN) message, comprising:
a computer processor;
memory storing instructions executable by the computer processor, wherein the instructions comprise:
an OSN application configured to:
obtain delivery status and content of the OSN message, wherein the OSN message is sent by a first user to a second user, and
exchange, by the first user, social interaction messages with OSN friends of the first user,
wherein the second user is not able to view the OSN message using the OSN application;
a message manager configured to:
determine the delivery status as meeting a pre-determined criteria; and
generate a text message comprising the content of the OSN message; and
a text messaging service (TMS) module configured to:
send, in response to determining the delivery status as meeting the pre-determined criteria, the text message using a text messaging service (TMS) to the second user of the OSN application; and
a repository for storing the OSN message.

9. The system of claim 8,
wherein the delivery status comprises an indication that the second user has not viewed the OSN message within a pre-determined time period since the OSN message was sent by the first user using the OSN application.

10. The system of claim 8,
wherein the OSN application is accessed by the second user based on a network data service subscribed by the second user, and
wherein the second user receives and views the text message using the TMS separate from the network data service.

11. The system of claim 10,
wherein the delivery status comprises an indication that the second user is offline from the network data service and is not able to view the OSN message using the OSN application.

12. The system of claim 8,
wherein the delivery status and the content are obtained via an application programming interface of the OSN application.

13. The system of claim 8,
wherein the TMS module is further configured to receive, in response to sending the text message, a reply text message from the second user, wherein the second user sends the reply text message using the TMS to reply to the OSN message from the first user,
wherein the message manager is further configured to generate an OSN reply message comprising content of the reply text message, and
wherein the OSN module is further configured to send the OSN reply message using the OSN application to the first user.

14. The system of claim 8, wherein the OSN module is further configured to:
send the OSN reply message using the OSN application to a third user of the OSN application,
wherein the OSN message is a group message having the second user and the third user as recipients.

15. A non-transitory computer readable storage medium comprising software instructions for delivering an online social network (OSN) message, that when executed, comprise functionality for:
obtaining delivery status and content of the OSN message, wherein the OSN message is sent by a first user using an OSN application to a second user;
generating a text message comprising the content of the OSN message; and
sending, in response to the delivery status meeting a pre-determined criteria, the text message using a text messaging service (TMS) to the second user,
wherein the OSN application is used by the first user to exchange social interaction messages with OSN friends of the first user, and
wherein the second user is not able to view the OSN message using the OSN application.

16. The non-transitory computer readable storage medium of claim 15,
wherein the delivery status comprises an indication that the second user has not viewed the OSN message within a pre-determined time period since the OSN message was sent by the first user using the OSN application.

17. The non-transitory computer readable storage medium of claim 15,
wherein the OSN application is accessed by the second user based on a network data service subscribed by the second user, and
wherein the second user receives and views the text message using the TMS separate from the network data service.

18. The non-transitory computer readable storage medium of claim 17,
wherein the delivery status comprises an indication that the second user is offline from the network data service.

19. The non-transitory computer readable storage medium of claim 15,
wherein the delivery status and the content are obtained via an application programming interface of the OSN application.

20. The non-transitory computer readable storage medium of claim 15, further comprising:
receiving, in response to sending the text message, a reply text message from the second user, wherein the second user sends the reply text message using the TMS to reply to the OSN message from the first user; and
generating an OSN reply message comprising content of the reply text message; and
sending the OSN reply message using the OSN application to the first user.

21. The non-transitory computer readable storage medium of claim 15, further comprising:
sending the OSN reply message using the OSN application to a third user of the OSN application,
wherein the OSN message is a group message having the second user and the third user as recipients.
